(19) United States
(12) Patent Application Publication
(10) Pub. No.: US 2022/0389908 A1
(43) Pub. Date: Dec. 8, 2022

(54) WIND POWER GENERATOR

(71) Applicant: EXEDY Corporation, Osaka (JP)

(72) Inventor: Yoshihiro MATSUOKA, Osaka (JP)

(21) Appl. No.: 17/738,476

(22) Filed: May 6, 2022

(30) Foreign Application Priority Data
Jun. 7, 2021 (JP) 2021-094929

(51) Int. Cl. F03D 9/25; F03D 3/06; F03D 15/00; F03D 3/00; H02K 7/10; H02K 7/18

(52) U.S. Cl. CPC F03D 9/25; F03D 3/06; F03D 15/00; F03D 3/005; H02K 7/10; H02K 7/183; F05B 2220/706; F05B 2260/40; F05B 2240/221; F05B 2270/101

(57) ABSTRACT

A wind power generator is disclosed. The wind power generator includes a wind rotor, a fluid coupling, and a rotary electric machine. The wind rotor is disposed to be rotatable. The fluid coupling includes an impeller receiving a torque inputted thereto from the wind rotor, and a turbine receiving the torque transmitted thereto from the impeller through a hydraulic fluid. The rotary electric machine is configured to generate electricity by the torque transmitted thereto from the turbine.

### CROSS-REFERENCE TO RELATED APPLICATIONS

This application claims priority to Japanese Patent Application No. 2021-094929 filed Jun. 7, 2021. The entire contents of that application are incorporated by reference herein in their entirety.

### TECHNICAL FIELD

The present invention relates to a wind power generator.

### BACKGROUND ART

A wind power generator or wind turbine is configured to generate electricity by utilizing rotation of a wind rotor or pinwheel. The wind rotor can be classified into a horizontal-axis type or a vertical-axis type. For example, Japan Laid-open Patent Application Publication No. 2020-051288 discloses a wind power generator that employs a Darrieus wind rotor classified as the vertical-axis wind rotor. The Darrieus wind rotor is of a vertical-axis lift type and has a merit of outputting a high power of electricity.

The wind power generator has been demanded to reduce a torque required to start rotating the wind rotor thereof. Especially, the Darrieus wind rotor described above requires a large torque to start rotating; this results in a drawback of poor starting performance.

It is an object of the present invention to provide a wind power generator enabling enhancement in starting performance.

### BRIEF SUMMARY

A wind power generator according to an aspect of the present invention includes a wind rotor, a fluid coupling, and a rotary electric machine. The wind rotor is disposed to be rotatable. The fluid coupling includes an impeller receiving a torque inputted thereto from the wind rotor and a turbine receiving the torque transmitted thereto from the impeller through a hydraulic fluid. The rotary electric machine is configured to be capable of generating electricity by the torque transmitted thereto from the turbine.

According to this configuration, the wind rotor is connected to the impeller of the fluid coupling; hence, a torque for starting rotation of the wind rotor can be made small in magnitude. As a result, the wind power generator can be enhanced in starting performance.

Preferably, the fluid coupling includes a first stator disposed between the impeller and the turbine.

Preferably, the fluid coupling includes an input shaft extending downward from the wind rotor. The input shaft is coupled to the impeller in a state of penetrating the turbine. The impeller is disposed below the turbine.

Preferably, the fluid coupling includes a cover fixed to the turbine. The cover forms an outer shell of the fluid coupling in cooperation with the turbine. The cover outputs the torque inputted thereto from the turbine to the rotary electric machine.

Preferably, the impeller is disposed below the turbine. The cover is disposed below the impeller. The impeller is disposed inside the outer shell.

Preferably, the fluid coupling includes a clutch. The clutch is attached to the impeller. The clutch is configured to transmit the torque inputted thereto from the impeller to the cover.

Preferably, the clutch is of a centrifugal type.

Preferably, the wind power generator further includes a first transmission. The first transmission is configured to change a speed of rotation inputted thereto from the wind rotor and transmit the rotation changed in speed to the fluid coupling.

Preferably, the first transmission is configured to reduce the speed of the rotation inputted thereto from the wind rotor and transmit the rotation reduced in speed to the fluid coupling.

Preferably, the wind power generator further includes a second transmission. The second transmission is configured to change the speed of the rotation inputted thereto from the fluid coupling and transmit the rotation changed in speed to the rotary electric machine.

Preferably, the wind rotor is of a vertical-axis lift type.

Overall, according to the present invention, the wind power generator can be enhanced in starting performance.

### BRIEF DESCRIPTION OF THE DRAWINGS

FIG. 1 is a schematic cross-sectional view of a wind power generator.

FIG. 2 is a chart showing a relation between a rotational speed of a wind rotor and a rotational load torque.

FIG. 3 is a schematic cross-sectional view of a wind power generator according to a modification.

FIG. 4 is a schematic cross-sectional view of a wind power generator according to another modification.

### DETAILED DESCRIPTION

A wind power generator or wind turbine according to a preferred embodiment will be hereinafter explained with reference to drawings. It should be noted that in the following explanation, the term “axial direction” refers to an extending direction of a rotational axis O of a torque converter. On the other hand, the term “radial direction” refers to a radial direction of an imaginary circle about the rotational axis O.

[Wind Power Generator]

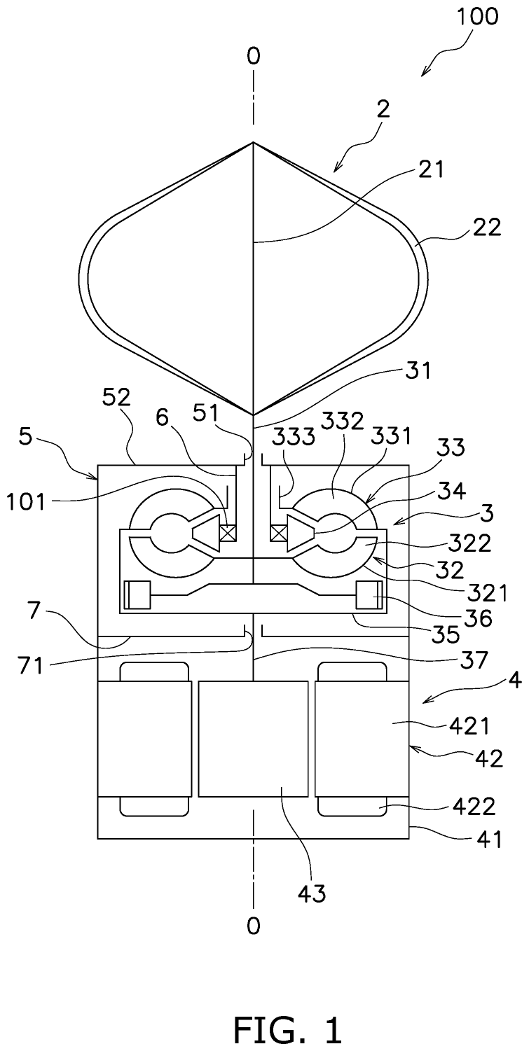

As shown in FIG. 1, a wind power generator or wind turbine 100 includes a wind rotor or pinwheel 2, a torque converter 3 (exemplary fluid coupling), and a rotary electric machine 4. Besides, the wind power generator 100 includes a first casing 5 and a tubular member 6.

[Wind Rotor]

The wind rotor 2 is disposed to be rotatable. The wind rotor 2 has a rotational axis arranged coaxial to the rotational axis O of the torque converter 3. The rotational axis of the wind rotor 2 extends in a vertical direction. In other words, the wind rotor 2 is of a vertical-axis type.

The wind rotor 2 includes a support body 21 and a plurality of blades 22. The support body 21 supports the plural blades 22. The support body 21 has a rodlike shape and extends coaxial to the rotational axis O.

The plural blades 22 are supported by the support body 21. The blades 22 are of a lift type. In other words, the wind rotor 2 according to the present preferred embodiment is of a vertical-axis lift type. It should be noted that the wind rotor 2 according to the present preferred embodiment is of a Darrieus type.

[Casing and Tubular Member]

The first casing 5 is disposed below the wind rotor 2. The first casing 5 accommodates the torque converter 3. The first casing 5 includes a top plate 52 provided with a through hole 51.

The tubular member 6 is disposed inside the first casing 5. The tubular member 6 extends downward from the top plate 52 of the first casing 5. The tubular member 6 is fixed to the top plate 52. The tubular member 6 is disposed to be non-rotatable. The tubular member 6 has a cylindrical shape. The inner space of the tubular member 6 communicates with the through hole 51. The tubular member 6 penetrates a turbine hub 333 (to be described).

[Torque Converter]

The torque converter 3 is disposed below the wind rotor 2. The torque converter 3 is disposed between the wind rotor 2 and the rotary electric machine 4. The torque converter 3 is disposed inside the first casing 5.

The torque converter 3 is configured to amplify a torque outputted from the wind rotor 2 and output the amplified torque to the rotary electric machine 4. The torque converter 3 is disposed to be rotatable. The rotational axis O of the torque converter 3 extends in the vertical direction. The torque converter 3 includes an input shaft 31, an impeller 32, a turbine 33, a first stator 34, a cover 35, a clutch 36, and an output shaft 37.

The input shaft 31 extends downward from the wind rotor 2. It should be noted that the input shaft 31 may be provided as a single member integrated with the support body 21 of the wind turbine 2. The input shaft 31 is a component to which the torque outputted from the wind rotor 2 is inputted. The input shaft 31 extends to penetrate the turbine 33. When described in detail, the input shaft 31 penetrates the through hole 51 of the first casing 5 and extends inside the tubular member 6. Besides, the input shaft 31 is joined to the impeller 32.

The impeller 32 is a component to which the torque outputted from the wind rotor 2 is inputted. When described in detail, the impeller 32 is a component to which the torque outputted from the wind rotor 2 is inputted through the input shaft 31. The impeller 32 is fixed to the input shaft 31. The impeller 32 is rotated unitarily with the input shaft 31. The impeller 32 is disposed below the turbine 33.

The impeller 32 includes an impeller shell 321 and a plurality of impeller blades 322. The plural impeller blades 322 are attached to the inner surface of the impeller shell 321.

The impeller shell 321 is fixed to the input shaft 31. For example, the input shaft 31 may be fixed to the impeller shell 321 by spline coupling or alternatively by welding or so forth.

The turbine 33 is disposed opposite to the impeller 32. When described in detail, the turbine 33 is axially opposed to the impeller 32. The turbine 33 is disposed above the impeller 32. The turbine 33 is a component to which the torque is transmitted from the impeller 32 through hydraulic fluid (e.g., hydraulic oil).

The turbine 33 includes a turbine shell 331, a plurality of turbine blades 332, and a turbine hub 333. The plural turbine blades 332 are fixed to the inner surface of the turbine shell 331.

The turbine hub 333 is fixed to the inner peripheral end of the turbine shell 331. For example, the turbine hub 333 is fixed to the turbine shell 331 by at least one rivet. The turbine hub 333 may be provided as a different member separated from the turbine shell 331, or alternatively, may be provided as a single member integrated with the turbine shell 331.

The turbine hub 333 may be supported by the tubular member 6 through a bearing or so forth.

The first stator 34 is configured to regulate the flow of the hydraulic oil returning from the turbine 33 to the impeller 32. The first stator 34 is rotatable about the rotational axis O. For example, the first stator 34 is supported by the tubular member 6 through a one-way clutch 101. The first stator 34 is disposed axially between the impeller 32 and the turbine 33.

The cover 35 is fixed to the turbine 33 and is unitarily rotated therewith. The cover 35 outputs the torque, inputted thereto from the turbine 33, to the rotary electric machine 4.

The cover 35 is disposed below the impeller 32. In other words, the turbine 33, the impeller 32, and the cover 35 are disposed in this order from above. It should be noted that the first stator 34 is disposed between the turbine 33 and the impeller 32. Besides, the clutch 36 is disposed between the impeller 32 and the cover 35.

The cover 35 composes an outer shell of the torque converter 3 in cooperation with the turbine 33. The impeller 32 is disposed inside the outer shell composed of the cover 35 and the turbine 33.

The outer shell, composed of the cover 35 and the turbine 33, is not provided with any hole facing downward. Because of this, the hydraulic fluid, supplied to the interior of the outer shell, can be prevented from leaking downward.

The clutch 36 is attached to the impeller 32 and is unitarily rotated therewith. The clutch 36 is configured to transmit the torque, inputted thereto from the impeller 32, to the cover 35. When described in detail, the clutch 36 transmits the torque, inputted thereto from the impeller 32, to the cover 35 when the rotational speed of the impeller 32 becomes a predetermined value or greater. By contrast, the clutch 36 blocks transmission of the torque from the impeller 32 to the cover 35 when the rotational speed ofthe impeller 32 becomes less than the predetermined value. In this case, the torque, outputted from the impeller 32, is transmitted to the turbine 33 and the cover 35 through the hydraulic fluid. It should be noted that the clutch 36 is, for instance, a centrifugal clutch.

The output shaft 37 is configured to output the torque, inputted thereto from the cover 35, to the rotary electric machine 4. The output shaft 37 is unitarily rotated with the cover 35. The output shaft 37 is fixed to the cover 35. For example, the output shaft 37 may be fixed to the cover 35 by spline coupling, or alternatively, by welding or so forth.

[Rotary Electric Machine]

The rotary electric machine 4 is a component to which the torque, outputted from the wind rotor 2, is transmitted through the torque converter 3. The rotary electric machine 4 is configured to be capable of generating electricity by the torque inputted thereto from the turbine 33 of the torque converter 3. When described in detail, the torque is transmitted from the turbine 33 and the cover 35 to the rotary electric machine 4 through the output shaft 37.

The rotary electric machine 4 is usable not only as an electric power generator but also as an electric motor. The rotary electric machine 4 includes a second casing 41, a second stator 42, and a rotor 43. In the present preferred embodiment, the rotary electric machine 4 is of a so-called inner rotor type.

The second casing 41 is non-rotatable, while being fixed to the earth, a building, or so forth. The second casing 41 accommodates the second stator 42 and the rotor 43. The second casing 41 may be provided as a single member integrated with the first casing 5. A partition 7 is provided between the first casing 5 and the second casing 41 to divide the casings 5 and 41 from each other. The partition 7 includes a through hole 71. The through hole 71 is penetrated by the output shaft 37.

The second stator 42 is fixed to the inner peripheral surface of the second casing 41. The second stator 42 is non-rotatable. The second stator 42 includes a stator core 421 and a coil 422. The stator core 421 is formed by laminating a plurality of electromagnetic steel plates. The coil 422 is wound about the stator core 421. When described in detail, the coil 422 is wound about teeth of the stator core 421.

The rotor 43 is disposed to be rotatable. It should be noted that the rotational axis of the rotor 43 is arranged coaxial with the rotational axis O of the torque converter 3. The rotor 43 is disposed radially inside the second stator 42.

The rotor 43 is attached to the output shaft 37. The rotor 43 is unitarily rotated with the output shaft 37.

[Characteristics]

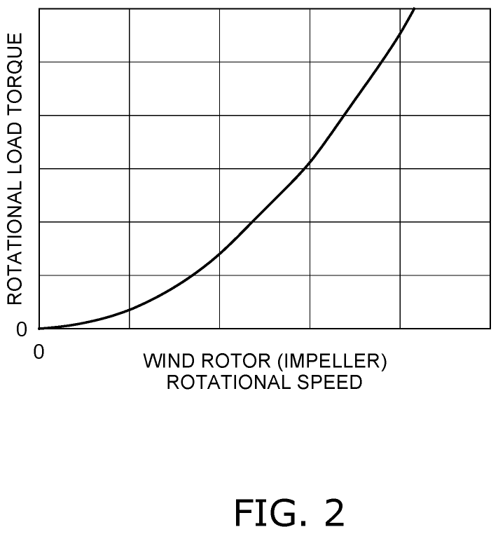

In the wind power generator 100 according to the present preferred embodiment, the wind rotor 2 is coupled to the impeller 32 of the torque converter 3. Because of this, as shown in FIG. 2, a torque required for starting rotation of the wind rotor 2 can be made small in magnitude. It should be noted that FIG. 2 is a chart showing a relation between the rotational speed of the wind rotor 2 and a rotational load torque.

[Modifications]

One preferred embodiment of the present invention has been explained above. However, the present invention is not limited to the above, and a variety of changes can be made without departing from the gist of the present invention.

Modification 1

In the preferred embodiment described above, the wind power generator 100 is configured to include the torque converter 3. However, the configuration of the wind power generator 100 is not limited to this. For example, the wind power generator 100 may include a type of fluid coupling without the first stator 34 instead of the torque converter 3.

Modification 2

In the preferred embodiment described above, the wind rotor 2 is provided as the Darrieus wind rotor. However, the wind rotor 2 is not limited to the Darrieus wind rotor and may be another wind rotor classified into the vertical-axis lift type. Alternatively, the wind rotor 2 may be of a vertical-axis drag type, a horizontal-axis lift type, or a horizontal-axis drag type.

Modification 3

In the preferred embodiment described above, the wind power generator 100 is configured to include the clutch 36, but alternatively, may be configured not to include the clutch 36.

Modification 4

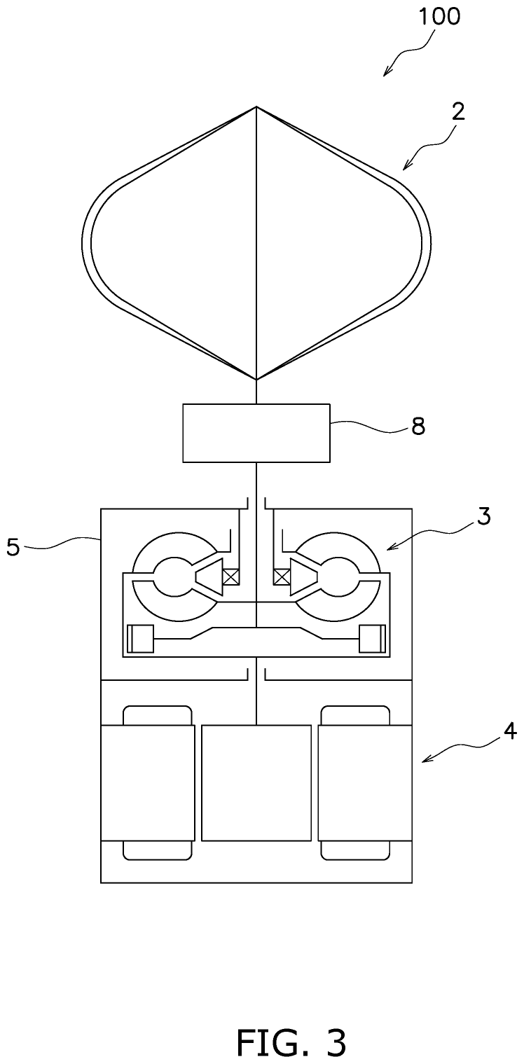

As shown in FIG. 3, the wind power generator 100 may further include a first transmission 8. The first transmission 8 is configured to change the speed of rotation inputted thereto from the wind rotor 2 and transmit the rotation changed in speed to the torque converter 3. For example, the first transmission 8 reduces the speed of rotation inputted thereto from the wind rotor 2 and transmit the rotation reduced in speed to the torque converter 3. Accordingly, the torque converter 3 can be inhibited from rotating at a high speed. It should be noted that the first transmission 8 may increase the speed of rotation inputted thereto from the wind rotor 2 and transmit the rotation increased in speed to the torque converter 3. Moreover, or alternatively, the first transmission 8 may be disposed inside the first casing 5.

Modification 5

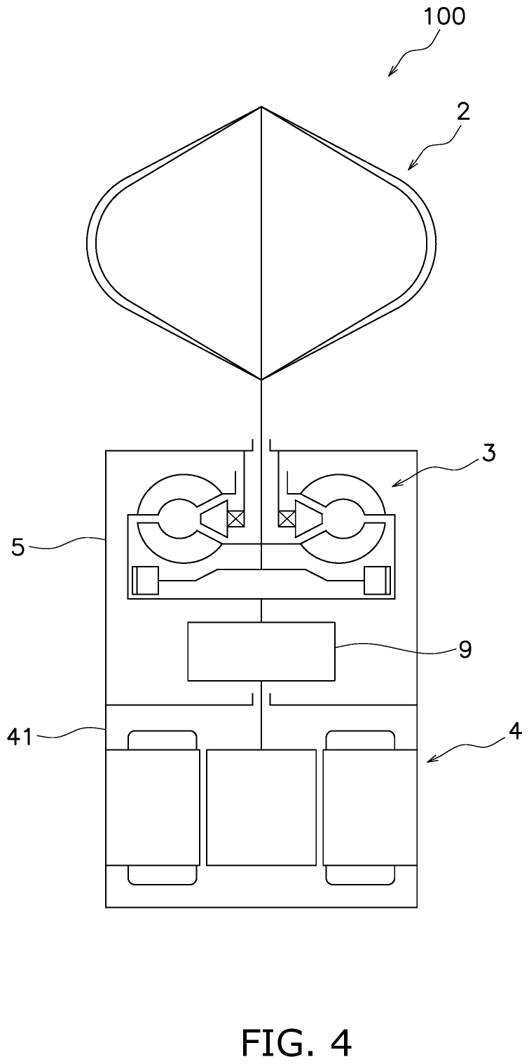

As shown in FIG. 4, the wind power generator 100 may further include a second transmission 9. The second transmission 9 is disposed inside the first casing 5. It should be noted that the second transmission 9 may be disposed inside the second casing 41.

The second transmission 9 is configured to change the speed of rotation inputted thereto from the torque converter 3 and transmit the rotation changed in speed to the rotary electric machine 4. For example, the second transmission 9 increases the speed of rotation inputted thereto from the torque converter 3 and transmits the rotation increased in speed to the rotary electric machine 4. It should be noted that the second transmission 9 may reduce the speed of rotation inputted thereto from the torque converter 3 and transmit the rotation reduced in speed to the rotary electric machine 4.

### REFERENCE SIGNS LIST

100: Wind power generator
2: Wind rotor
3: Torque converter
31: Input shaft
32: Impeller
33: Turbine
34: First stator
35: Cover
36: Clutch
4: Rotary electric machine
8: First transmission
9: Second transmission

What is claimed is:

1. A wind power generator comprising:
a wind rotor disposed to be rotatable;
a fluid coupling including an impeller and a turbine, the impeller configured to receive a torque inputted thereto from the wind rotor, the turbine configured to receive the torque transmitted thereto from the impeller through a hydraulic fluid; and
a rotary electric machine configured to generate electricity by the torque transmitted thereto from the turbine.

2. The wind power generator according to claim 1, wherein the fluid coupling includes a first stator disposed between the impeller and the turbine.

3. The wind power generator according to claim 1, wherein
the fluid coupling includes an input shaft extending downward from the wind rotor,
the input shaft is coupled to the impeller in a state of penetrating the turbine, and
the impeller is disposed below the turbine.

4. The wind power generator according to claim 1, wherein
the fluid coupling includes a cover fixed to the turbine, and
the cover forms an outer shell of the fluid coupling in cooperation with the turbine, the cover configured to output the torque inputted thereto from the turbine to the rotary electric machine.

5. The wind power generator according to claim 4, wherein
the impeller is disposed below the turbine,
the cover is disposed below the impeller, and
the impeller is disposed inside the outer shell.

6. The wind power generator according to claim 4, wherein the fluid coupling includes a clutch attached to the impeller, the clutch configured to transmit the torque inputted thereto from the impeller to the cover.

7. The wind power generator according to claim 6, wherein the clutch is of a centrifugal type.

8. The wind power generator according to claim 1, further comprising:
a first transmission configured to change a speed of rotation inputted thereto from the wind rotor and transmit the rotation changed in speed to the fluid coupling.

9. The wind power generator according to claim 8, wherein the first transmission is configured to reduce the speed of the rotation inputted thereto from the wind rotor and transmit the rotation reduced in speed to the fluid coupling.

10. The wind power generator according to claim 1, further comprising:
a second transmission configured to change a speed of rotation inputted thereto from the fluid coupling and transmit the rotation changed in speed to the rotary electric machine.

11. The wind power generator according to claim 1, wherein the wind rotor is of a vertical-axis lift type.
